(19) United States
(12) Patent Application Publication
(10) Pub. No.: US 2017/0214760 A1
(43) Pub. Date: Jul. 27, 2017

(54) PROXY DEVICE FOR CAR AND METHOD FOR MANAGING THE DATA FROM CAR

(71) Applicant: AutoFactory, Inc., Uijeongbu-si (KR)

(72) Inventors: Jae Wook LEE, Uijeongbu-si (KR); Byung Bog LEE, Daejeon (KR)

(21) Appl. No.: 15/009,167

(22) Filed: Jan. 28, 2016

(30) Foreign Application Priority Data
Jan. 27, 2016 (KR) 10-2016-0010288

(51) Int. Cl. H04L 29/08; G07C 5/00; H04W 4/00

(52) U.S. Cl. CPC H04L 67/2814; H04W 4/008; H04W 4/005; H04L 67/02; H04L 67/12; G07C 5/008

(57) ABSTRACT

Disclosed are a proxy device for a vehicle and a method of managing data from the vehicle. The managing method of the data from the vehicle includes receiving short message data from a vehicle proxy device through a lightweight message transmission protocol, receiving long message data from the vehicle proxy device through a web service message transmission method, and providing vehicle operation data and recording image data to a specific external server or a proxy device for a specific vehicle. The vehicle operation data correspond to the short message data, and the recording image data correspond to the long message data. Accordingly, the transmission efficiency of the data related to the vehicle may be improved.

### CROSS-REFERENCE TO RELATED APPLICATIONS

A claim for priority under 35 U.S.C. §119 is made to Korean Patent Application No. 10-2016-0010288 filed Jan. 27, 2016, in the Korean Intellectual Property Office, the entire contents of which are hereby incorporated by reference.

### BACKGROUND

Embodiments of the inventive concept described herein relate to a proxy device for a vehicle and a method of managing data from a vehicle in a data management server, and more particularly, relate to a proxy device capable of efficiently managing transmission and reception of data obtained from terminals installed in the vehicle and a method for effectively managing the obtained vehicle data.

As technologies, such as a network technology, an RFID technology, a software technology, etc., have been developed, various devices of the physical world are connected to an information technology infrastructure to form “Internet of Things (hereinafter, referred to as IoT)”. The IoT is the network of physical objects capable of accessing and sharing data through internet and supporting a connection between objects and humans.

In recent years, various terminals, e.g., a navigation unit, a black box unit, etc., are installed in the vehicle. In addition, vehicle operation data are obtained by an On-board diagnostics. As the number of electronic devices installed in the vehicle or vehicleried by a driver who drives the vehicle increases, the types of data obtained from the vehicle become more varied. To effectively use the data obtained from the vehicle, the data are required to be efficiently transmitted to an external server.

### SUMMARY

Embodiments of the inventive concept provide a proxy device for a vehicle, which transmits various data obtained from a vehicle in a small-capacity data transmission way performed frequently or a large-capacity data transmission way to enhance a transmission efficiency, and a method of managing data from a vehicle in a data management server.

One aspect of embodiments of the inventive concept is directed to provide a proxy device for a vehicle including a communication part that receives first data from one or more terminals in a first vehicle through a short range communication, provides second data provided from a second vehicle in a specific area or a data management server to a specific terminal in other vehicle, and performs a communication with the other vehicle or transmission and reception the first data or the second data to and from the data management server and an information processing part that determines a communication path to transmit the first data to the other vehicle or the data management server. The proxy device is included in the first vehicle.

The information processing part classifies the first data into short message data and long message data, the short message data are requested to be transmitted through a lightweight message transmission protocol, and the long message data are requested to be transmitted through a web service message transmission technology

In a case that the terminal is an OBD system, the first data are vehicle operation data provided from the OBD system, and the information processing part diagnoses a state of the vehicle based on the vehicle operation data and requests a specific terminal in the vehicle to provide the diagnostic results.

The information processing part determines whether a precision diagnostics is needed to be performed based on the diagnostic results and transmits the vehicle operation data or the diagnostic results to the data management server to perform the precision diagnostics.

In a case that the terminal is a wearable device worn on a passenger or a device installed in the vehicle to check the passenger's state, the information processing part analyzes the passenger's state and transmits the first data or data obtained by analyzing the passenger's state to an external server when it is determined that the passenger's state is an abnormal state.

In a case that the terminal is a driving data recording device, the information processing part determines whether a recording image obtained in real time is transmitted to the outside of the vehicle and requests to transmit the recording image to a second proxy device in one or more second vehicles approaching to a specific area, and the second proxy device requests a reproducing device in the second vehicle to output the recording image.

Another aspect of embodiments of the inventive concept is directed to provide a method of managing data from a vehicle, including receiving short message data, in which a data management server receives the short message data from a vehicle proxy device through a lightweight message transmission protocol, receiving long message data, in which the data management server receives the long message data from the vehicle proxy device through a web service message transmission method, and providing data, in which the data management server provides vehicle operation data and recording image data provided from the proxy device installed in one or more vehicles to a specific external server or a proxy device for a specific vehicle. The vehicle operation data correspond to the short message data, and the recording image data correspond to the long message data.

In a case that one or more vehicles are involved in an accident, the providing of the data includes receiving vehicle identification information and information on time of the accident, which correspond to one or more accident vehicles, from the external server, transmitting the vehicle operation data within a time range including the time of the accident of the vehicle corresponding to the vehicle identification information to the external server, and transmitting the recording image data obtained by a terminal in the accident vehicle or recording image data, in which the accident vehicle is recorded at the time of the accident, to the external server.

The receiving of the short message data includes receiving biometric signal data of a driver and further includes calculating an abnormal state of the driver based on the biometric signal data or an abnormal state of the vehicle based on the vehicle operation data.

The providing of the data includes providing notification information to a neighboring vehicle or a rescue vehicle.

According to the above, the embodiments of the present disclosure may have the following effects.

First, since the OBD proxy device is designed to support a selective message transmission method that transmits the short message data as the OBD data through the lightweight message transmission method and the long message data through the web service message transmission method, the transmission efficiency of the data related to the vehicle may be improved.

Second, since the data with small amount, e.g., the OBD data, are transmitted through the lightweight data transmission method, the data may be more frequently transmitted by the lightweight data transmission method than when the data with small amount are transmitted through the web service message transmission method. Accordingly, the vehicle may be easily monitored at all times, and a message transmission cost may be remarkably reduced.

Third, since the vehicle operation data, e.g., the OBD data, are received highly frequently, the vehicle's state may be continuously managed, if necessary. Since the vehicle operation data are continuously obtained, an odometer may be prevented from being tampered with, and thus reliability of the vehicle may be improved when trading the vehicle. In addition, for example, although the recording image data (i.e., a black box image) are difficult to be directly obtained from the vehicle when the vehicle is totally burned down by fire in an accident, the data stored in the vehicle may be safely stored in the data management server or transferred to parties concerned.

### BRIEF DESCRIPTION OF THE FIGURES

The above and other objects and features will become apparent from the following description with reference to the following figures, wherein like reference numerals refer to like parts throughout the various figures unless otherwise specified, and wherein:

FIG. 1 is a block diagram showing a connection between a proxy device for a car and a data management server according to an exemplary embodiment of the present disclosure;

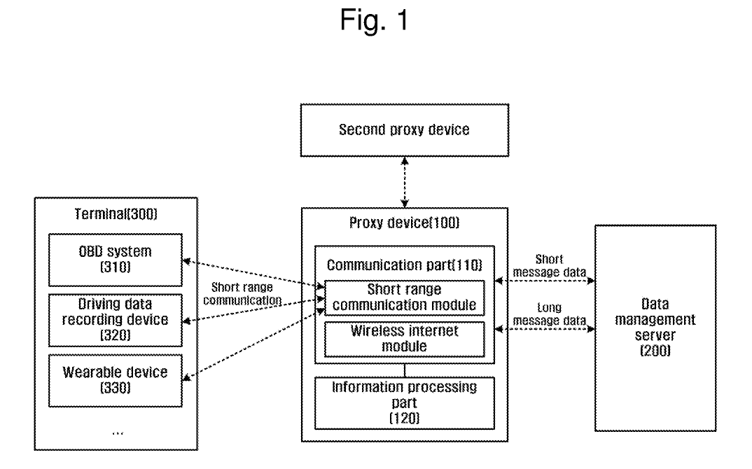

FIG. 2 is a flowchart showing a method of managing data from a vehicle according to an exemplary embodiment of the present disclosure; and

FIG. 3 is a flowchart showing a process of providing data requested from an external server at the event of an accident according to an exemplary embodiment of the present disclosure.

### DETAILED DESCRIPTION

Hereinafter, the following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness. Like numbers refer to like elements throughout.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The terminology used herein is for the purpose of describing particular embodiments only and is not intended to be limiting of the invention. As used herein, the singular forms, “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof.

In the following descriptions, the term “terminal” used herein means a device that collects data allowed to be transmitted to an external device, e.g., a data management server or another vehicle, from the vehicle. For instance, the terminal may include devices, such as a black box unit, a vehicle seat equipped with a sensor, a handle, an OBD device, etc., which are installed in the vehicle. In addition, the terminal may be, but not limited to, a wearable device worn on a user.

In the following descriptions, first data correspond to data obtained from a specific vehicle. Second data correspond to data applied to a proxy device in the vehicle from the outside of the vehicle. In the following descriptions, a first vehicle means a vehicle from which the first data are obtained, and a second vehicle means a vehicle other than the first vehicle.

In the following descriptions, vehicle data comprehensively mean data obtained from the vehicle. That is, the vehicle data may include data obtained by a plurality of devices installed in the vehicle and data obtained through devices carried by or worn on occupants.

In the following descriptions, the term “passenger” used herein means any person in the vehicle. In addition, the term “passenger” used herein may be further referred to as the driver who drives the vehicle or the user who wears the wearable device or is in an autonomous vehicle, if necessary.

In the following descriptions, vehicle operation data mean data related to a vehicle operation obtained by an On-board diagnostics (hereinafter, referred to as “OBD”). That is, the vehicle operation data may include information on a vehicle operation state (e.g., a speed, an operating hour, a revolution per minute (RPM), a mileage, an average fuel consumption, an instantaneous fuel consumption, etc.), information on an engine state (e.g., an engine speed, a coolant temperature, an intake air temperature, an intake air quantity, an engine oil temperature, a transmission oil temperature, a fuel injection quantity, an oxygen sensor voltage, an ignition angle, a carbon emission quantity, an air-fuel ratio learning value, etc.), and information on a vehicle state (e.g., a brake state, a battery voltage, a pressure of air conditioner coolant, etc.).

Hereinafter, a proxy device 100 for a vehicle (hereinafter, referred to as vehicle proxy device) and a method of managing the vehicle data of the data management server will be described in detail with reference to accompanying drawings.

The vehicle proxy device 100 includes a communication part 110 and an information processing part 120.

The vehicle proxy device 100 may be installed or provided in the vehicle and may correspond to a mobile terminal carried by a passenger (or a driver) including all terminals that the user may use while moving. That is, the mobile terminals may include a cellular phone, a personal communication service (PCS) phone, a synchronous-asynchronous international mobile telecommunication-2000 (IMT-2000) mobile phone, a palm personal computer, a personal digital assistant (PDA), a smart phone, a wireless application protocol (WAP) phone, a mobile game unit, a tablet PC, or the like.

The communication part 110 includes a wireless internet module and a short range communication module.

The short range communication module indicates a module for short range communication. As the short range communication technology, various technologies, such as Bluetooth, BLE (Bluetooth Low Energy), Beacon, RFID (Radio Frequency Identification), NFC (Near Field Communication), IrDA (Infrared Data Association), UWB (Ultra Wideband), ZigBee etc., are used.

The wireless internet module indicates a module for internet access, and the wireless internet module may be built-in or external to the proxy device 100. As the wireless internet technology, various technologies, such as WLAN (Wireless LAN)(Wi-Fi), Wibro (Wireless broadband), Wimax (World Interoperability for Microwave Access), HSDPA (High Speed Downlink Packet Access), LTE (long term evolution), LTE-A (Long Term Evolution-Advanced), etc., are used.

The communication part 110 may perform a function of receiving the first data from one or more terminals 300 in the first vehicle through the short range communication. For instance, the short range communication module may receive the vehicle operation data from an On-Board Diagnostics (hereinafter, referred to as OBD) system 310. That is, the OBD system 310 may obtain the information on the vehicle operation state (e.g., the speed, the operating hour, the revolution per minute (RPM), the mileage, the average fuel consumption, the instantaneous fuel consumption, etc.), the information on the engine state (e.g., the engine speed, the coolant temperature, the intake air temperature, the intake air quantity, the engine oil temperature, the transmission oil temperature, the fuel injection quantity, the oxygen sensor voltage, the ignition angle, the carbon emission quantity, the air-fuel ratio learning value, etc.), and the information on the vehicle state (e.g., the brake state, the battery voltage, the pressure of air conditioner coolant, etc.), and the proxy device 100 may receive the vehicle operation data from the OBD system 310 through the short range communication. The proxy device 100 receives the vehicle operation data from the OBD system 310 in real time or periodically.

In addition, for example, in the case that the terminal 300 is a driving data recording device 320, the short range communication module may receive image data, e.g., a front image taken while driving or parking, from the driving data recording device 320, e.g., a vehicle's black box.

Further, for example, in the case where the terminal 300 is a wearable device 330 or a device installed in the vehicle to check a passenger's state, the short range communication module may receive data about the passenger's state from the wearable device 330.

The communication part 110 may perform a communication with the other vehicle or may transmit and receive the first data or the second data to and from the data management server 200. As described below, the communication part 110 transmits and receives the first data or the second data to and from the data management server 200 in accordance with a communication path or a communication method, which is decided by the information processing part 120. As an example, in the case that the amount of the data to be transmitted is small or frequent data transmission is required, the communication part 110 may transmit the data through a lightweight data transmission protocol (lightweight data transmission method) in response to a request from the information processing part 120. For instance, even though OBD data or user's biometric data are small in terms of the data amount, the OBD data or user's biometric data are required to be frequently transmitted unlike the case of the other file transfer. In this case, when the OBD data or user's biometric data are transmitted by the protocol in the lightweight data transmission other than a mass data transmission method, a transmission cost may be reduced and an efficiency of the data transmission/reception may be improved. As the lightweight data transmission protocol, a message push service technology based on a message push transmission broker, such as an MQTT (Message Queue Telemetry Transport) used to access a short data message of Internet of Things, may be used.

As another embodiment, a web service message transmission technology, e.g., RESTful technology, may be used to exchange a long message with large amount of data. Since driving image data obtained by the driving data recording device 320 placed in the vehicle are large in volume, the driving image data may be transmitted to the data management server 200 or the second vehicle using the web service message transmission technology. In the case where the driving image data (or recoded image) are directly transmitted to the second vehicle, the communication part 110 may set the transmission range to allow the driving image data to be transmitted to vehicles only in a specific range.

The communication part 110 may receive the second data from the second vehicle in the specific range or the data management server 200 and provide the second data to the terminal 300 in the vehicle. For instance, the communication part 110 may provide the driving image (or recorded image), which is provided from the data management server 200 through the short range communication, to the terminal 300, e.g., a navigation unit, an HUD device, etc., to reproduce the driving image.

The information processing part 120 may perform a function of deciding a communication path to transmit the first data to the second vehicle or the data management server 200. For example, the information processing part 120 may decide to allow specific first data obtained from specific terminal 300 in the first vehicle to be transmitted in either the lightweight message transmission technology or the web service message transmission technology.

In addition, the information processing part 120 may classify the first data into short message data and long message data. Since the information processing part 120 classifies the first data into the short message data and the long message data, the short and long message data may be transmitted through appropriate communication methods, respectively. For instance, the information processing unit 120 may request the first data classified into the short message data to be transmitted through the lightweight message transmission protocol and may request the first data classified into the long message data to be transmitted through the web service message transmission technology.

The information processing part 120 may classify the first data into the short message data and the long message data in various ways. For instance, the information processing part 120 checks a packet size of the data in real time, recognizes the data in which the packet size is smaller than a specific size as the short message, and recognizes the data in which the packet size is equal to or greater than the specific size as the long message. In addition, the information processing part 120 analyzes a format of the data provided through the communication part 110 to distinguish the short message data and the long message data from each other. That is, the data expressed in hex code as normalized OBD data are processed as the short message data, and other data are processed as the long message data. However, the method of classifying the first data into the short message data and the long message data by the information processing part 120 should not be limited to the above-mentioned method.

In addition, the information processing part 120 may perform a function corresponding to the kind of the terminal 300 or the format of the first data provided from each terminal 300. As an example, in the case that the vehicle operation data are provided to the information processing part 120 as the first data since the terminal 300 is the OBD system 310, the information processing part 120 may diagnose the vehicle's state on the basis of the vehicle operation data. That is, the information processing part 120 includes an algorithm to perform the functions of vehicle diagnostics based on the vehicle operation data provided from the OBD system 310, and thus the information processing part 120 calculates diagnostic results about the vehicle's state. In addition, the information processing part 120 may request the communication part 110 to transmit the diagnostic results of the vehicle's state to the specific terminal 300 in the vehicle, so that the diagnostic results of the vehicle's state are visually displayed to the passenger through the specific terminal 300.

Further, the information processing part 120 determines whether precision diagnostics is needed to be performed based on the diagnostic results and allows the communication part 110 to transmit the vehicle operation data or the diagnostic results to the data management server 200 for the precision diagnostics. That is, in the case where the precision diagnostics is required, e.g., the diagnostic results about the vehicle are not precisely calculated, there is a serious flaw in the vehicle's diagnostic results, etc., the information processing part 120 may transmit the vehicle operation data to the data management server 200 that performs the precision diagnostics on the vehicle. In addition, the information processing part 120 may request the communication part 110 to transmit the data related to the diagnostic results and the vehicle operation data to the data management server 200 in order to refer to existing diagnostic results or to access accuracy of the diagnostic results of the proxy device 100 when the precision diagnostics is performed. In the case where it is determined that the accuracy of the diagnostic results of the proxy device 100 is low by the data management server 200, the information processing part 120 receives data, which is necessary to update the algorithm of calculating the diagnostic results, from the data management server 200 and updates the algorithm.

As another embodiment, in the case that the terminal 300 is a wearable device 330 of the passenger or a device installed in the vehicle to check the passenger's state, the information processing part 120 analyzes the passenger's state. When it is determined that the passenger's state is abnormal, the information processing part 120 transmits the first data or data obtained by analyzing the passenger's state to an external server. For instance, the proxy device 100 receives biometric signals of a wearer, e.g., the passenger or the driver, which are measured by the wearable device 330, and diagnoses the wearer's state. The proxy device 100 includes reference data or algorithm to determine the passenger's state. When it is determined that the wearer's state is abnormal, the information processing part 120 of the proxy device 100 transmits the biometric signal data (i.e., the first data) or the analyzing data of the passenger's state (or wearer's state) to the external server. The external server may be, but not limited to, the data management server 200 or a server belonging to institutions (e.g., an emergency patient management server, a server for 119 Rescue, etc.) corresponding to the passenger's situation.

In detail, in the case where the user gets in an autonomous vehicle, a state of the user who is alone in the vehicle is difficult to be checked from the outside of the autonomous vehicle since the vehicle drives itself. Accordingly, it is required to calculate the user's state on the basis of the biometric signal data provided from the wearable device 330 worn on the passenger or sensing data (e.g., the biometric signal or movement data of the user) sensed by components (e.g., a seat) of the vehicle, with which the passenger's body makes contact. The proxy device 100 receives the sensing data from the wearable device 330 or user's state sensing devices installed in the vehicle at a specific time interval and checks the user's state based on the sensing data. When it is determined that the user's state is abnormal, the proxy device 100 transmits the determined result to the external server (e.g., a vehicle control server) to control the vehicle or to change destination of the vehicle.

As another embodiment, in the case that the terminal 300 is the driving data recording device 320, the information processing part 120 determines whether the recording image obtained in real time is transmitted to the outside or not and requests the recording image to be transmitted to a second proxy device in the second vehicle approaching a specific area. For example, when a vehicle accident occurs in the specific area and the driving data recording device 320 (i.e., the black box) installed in the first vehicle takes a picture of the accident, the information processing part 120 analyzes the recording image data or transmits the recording image data to the data management server 200 in response to the user's request. The data management server 200 may transmit the recording image data provided from the proxy device 100 (i.e., a first proxy device 100) of the first vehicle to one or more second vehicles approaching the accident scene, and the second proxy device (i.e., the proxy device 100 of the second vehicle) may request a specific reproducing device in the second vehicle to reproduce the recording image data. Since the recording image data are large in size, the recording image data may be transmitted in the web service message transmission technology when the recording image data are transmitted to the data management server 200 from the first proxy device 100 and to the second proxy device from the data management server 200.

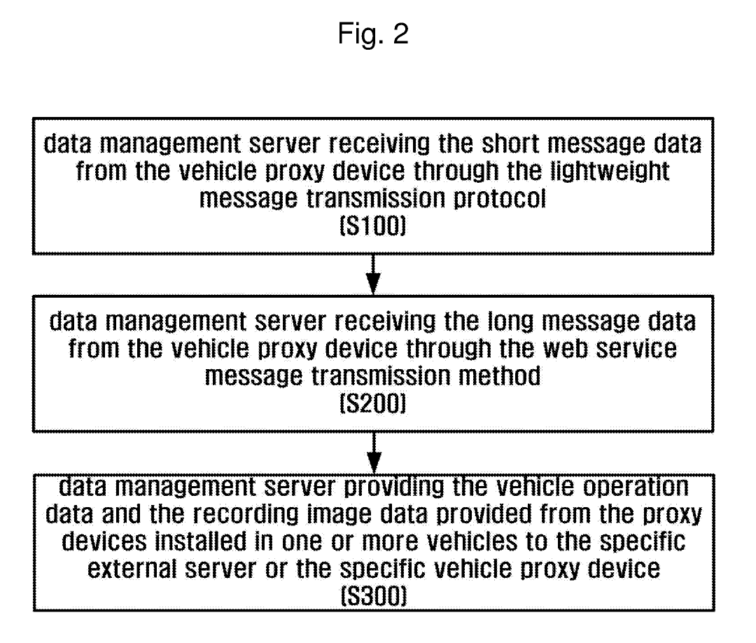

FIG. 2 is a flowchart showing a method of managing data from a vehicle according to an exemplary embodiment of the present disclosure.

Referring to FIG. 2, the managing method of the data from the vehicle includes a short message data receiving operation in which the data management server 200 receives the short message data from the vehicle proxy device 100 through the lightweight message transmission protocol (S100), a long message data receiving operation in which the data management server 200 receives the long message data from the vehicle proxy device 100 through the web service message transmission method (S200), and a data transmission operation in which the data management server 200 provides the vehicle operation data and the recording image data provided from the proxy devices 100 installed in one or more vehicles to the specific external server or the specific vehicle proxy device 100 (S300). The vehicle operation data correspond to the short message data, and the recording image data correspond to the long message data. Hereinafter, the managing method of the data from the vehicle will be described in detail.

The data management server 200 receives the short message data from the vehicle proxy device 100 through the lightweight message transmission protocol (S100). The short message data means a message with small capacity. In the case of the vehicle operation data and the biometric signal data, each of which have the small capacity and are frequently transmitted, it is inefficient that the vehicle operation data and the biometric signal data are transmitted through the communication method suitable for the transmission of a large amount of data. Therefore, the short message data are transmitted through the communication method (e.g., the lightweight message transmission protocol like the MQTT) specialized to transmit the lightweight message.

The data management server 200 receives the long message data from the vehicle proxy device 100 through the web service message transmission method (S200). The long message data correspond to the large amount of data. That is, the data management server 200 transmits and receives the large amount of data, e.g., a moving image, a still image (photograph), etc., to and from the proxy device 100 installed in each vehicle through the web service message transmission method suitable for the transmission of the large amount of data.

The data management server 200 provides the vehicle operation data and the recording image data provided from the proxy device 100 installed in one or more vehicles to the specific external server or the specific vehicle proxy device 100 (S300). The vehicle operation data are data related to the vehicle operation and obtained by the OBD system 310. The vehicle operation data correspond to the short message data, which are small in size. The recording image data are obtained by the driving data recording device 320 (e.g., the black box) and correspond to the long message data, which are large in size. The data management server 200 transmits the vehicle operation data and the recording image data provided from the first proxy device 100 (i.e., the proxy device 100 of the first vehicle) to the second proxy device (i.e., the proxy device 100 of the second vehicle) or the external server.

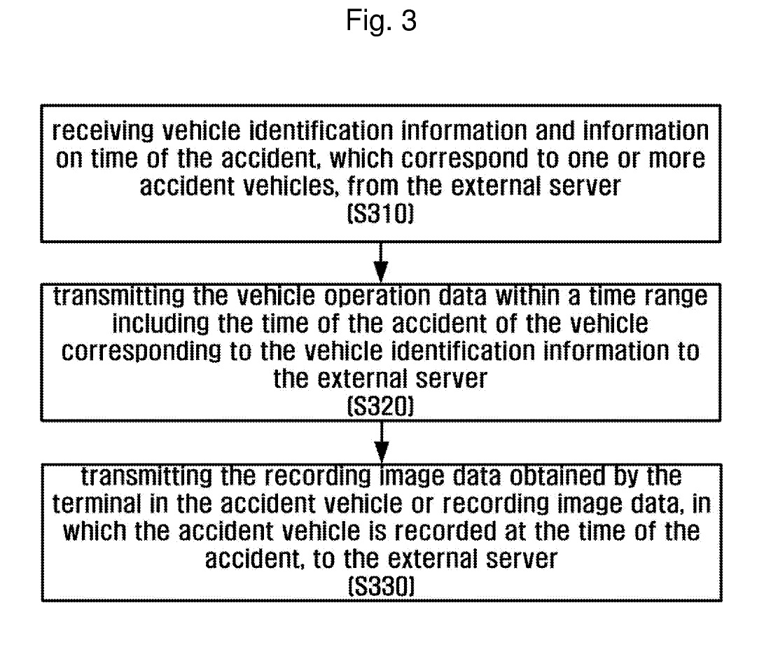

The data providing operation (S300) may perform additional operations depending on specific situations. As an exemplary embodiment, in the case where one or more vehicles are involved in the accident, the data management server 200 may extract the vehicle operation data or the recording image data, which are necessary to understand the accident situation, and transmit the vehicle operation data or the recording image data to the external server. The external server may be, but not limited to, a server (e.g., a server of police department) analyzing the accident situation. To this end, as shown in FIG. 3, the data providing operation (S300) may include receiving vehicle identification information and information on time of the accident, which correspond to one or more accident vehicles, from the external server (S310), transmitting the vehicle operation data within a time range including the time of the accident of the vehicle corresponding to the vehicle identification information to the external server (S320), and transmitting the recording image data obtained by the terminal 300 in the accident vehicle or recording image data, in which the accident vehicle is recorded at the time of the accident, to the external server (S330).

The data management server 200 may receive the vehicle identification information and the information on the time of the accident, which correspond to one or more accident vehicles, from the external server (S310). For instance, the data management server 200 may receive the vehicle identification information and the information on the time of the accident of the accident vehicles from the server of the police department.

Then, the data management server 200 may transmit the vehicle operation data within the time range including the time of the accident of the vehicle corresponding to the vehicle identification information to the external server (S320). After that, the data management server 200 may transmit the recording image data obtained by the terminal 300 in the accident vehicle or recording image data, in which the accident vehicle is recorded at the time of the accident, to the external server (S330). The external server may receive the vehicle operation data of the accident vehicle and the recording image data related to the accident scene at the time of accident, and thus the external server may easily analyze a cause of the vehicle accident.

In addition, the managing method of the data from the vehicle according to the present exemplary embodiment may further include calculating an abnormal state of the passenger based on the biometric signal data or an abnormal state of the vehicle. To this end, the data management server 200 may receive the biometric signal data of the passenger from the proxy device 100. Since the biometric signal data are small in size and frequently transmitted as the vehicle operation data, the data management server 200 may receive the biometric signal data of the passenger through the lightweight message transmission method. The data management server 200 may check a present state of the passenger on the basis of the biometric signal data applied thereto and a present state of the vehicle on the basis of the vehicle operation data.

In addition, the data providing operation (S300) may further include providing notification information to a neighboring vehicle driving adjacent to the passenger or a rescue vehicle. In detail, in the case where the passenger is in the abnormal state or the vehicle is in the abnormal state, the data management server 200 transmits the notification information to the proxy device 100, the terminal 300 (e.g., a terminal belonging to a passenger or a proxy device of the rescue vehicle, the neighboring vehicle, a towing vehicle, or a police vehicle), or a server (e.g., a server of insurance company, a patient management server, etc.). Accordingly, the accidents caused by the abnormal state of the passenger or vehicle may be prevented from occurring.

The managing method of the data from the vehicle according to the present exemplary embodiment may be stored in a medium after being realized in a program or an application suitable for being executed in a computer.

The above-mentioned program may include codes coded by a computer language, such as C, C++, JAVA, a machine language, or the like, which are readable by a processor (CPU) of the computer through a device interface of the computer.

These codes may include functional codes related to a mathematical function in which the functions described above are defined and may include control codes related to execution procedures, which are required for the processor of the computer to execute the functions described above according to predetermined procedures. In addition, these codes may further include additional information required for the processor of the computer to execute the functions described above and memory reference-related codes with respect to a location (address) within an internal or external memory of the computer. In addition, in the case where the processor of the computer needs to communicate with any other remote computer or server to execute the functions described above, the codes may further include communication-related codes with respect to how the processor of the computer communicates with any other remote computer or server using a communication module of the computer, what kind of information or media is to be transmitted and received in the communication, and the like.

The recording medium indicates a medium that semi-permanently stores the data and that is readable by machines other than a medium that stores the data for a short time, such as a register, a cache, a memory, etc. In detail, examples of the recording medium in which the program is recorded include ROM, RAM, CD-ROM, a magnetic tape, a floppy disc, an optical media storage device, and the like, but it should not be limited thereto or thereby. That is, the program may be recorded in various recording media of various servers to which the computer may access or in various recording media of the computer of the user. In addition, the recording medium may be distributed over a network coupled computer system, so that the computer-readable code may be stored and executed in a distributed fashion.

While the inventive concept has been described with reference to exemplary embodiments, it will be apparent to those skilled in the art that various changes and modifications may be made without departing from the spirit and scope of the inventive concept. Therefore, it should be understood that the above embodiments are not limiting, but illustrative.

What is claimed is:

1. A proxy device for a vehicle, comprising:
a communication part receiving first data from one or more terminals in a first vehicle through a short range communication, providing second data provided from a second vehicle in a specific area or a data management server to a specific terminal in other vehicle, and performing a communication with the other vehicle or transmission and reception the first data or the second data to and from the data management server; and
an information processing part determining a communication path to transmit the first data to the other vehicle or the data management server, wherein the proxy device is included in the first vehicle.

2. The proxy device of claim 1, wherein the information processing part classifies the first data into short message data and long message data, the short message data are requested to be transmitted through a lightweight message transmission protocol, and the long message data are requested to be transmitted through a web service message transmission technology.

3. The proxy device of claim 2, wherein in a case that the terminal is an OBD system, the first data are vehicle operation data provided from the OBD system, and the information processing part diagnoses a state of the vehicle based on the vehicle operation data and requests a specific terminal in the vehicle to provide the diagnostic results.

4. The proxy device of claim 3, wherein the information processing part determines whether a precision diagnostics is needed to be performed based on the diagnostic results and transmits the vehicle operation data or the diagnostic results to the data management server to perform the precision diagnostics.

5. The proxy device of claim 1, wherein in a case that the terminal is a wearable device worn on a passenger or a device installed in the vehicle to check the passenger's state, the information processing part analyzes the passenger's state and transmits the first data or data obtained by analyzing the passenger's state to an external server when it is determined that the passenger's state is an abnormal state.

6. The proxy device of claim 1, wherein in a case that the terminal is a driving data recording device, the information processing part determines whether a recording image obtained in real time is transmitted to the outside of the vehicle and requests to transmit the recording image to a second proxy device in one or more second vehicles approaching to a specific area, and the second proxy device requests a reproducing device in the second vehicle to output the recording image.

7. A method of managing data from a vehicle, comprising:
receiving short message data, in which a data management server receives the short message data from a vehicle proxy device through a lightweight message transmission protocol;
receiving long message data, in which the data management server receives the long message data from the vehicle proxy device through a web service message transmission method; and
providing data, in which the data management server provides vehicle operation data and recording image data provided from the proxy device installed in one or more vehicles to a specific external server or a proxy device for a specific vehicle, wherein the vehicle operation data correspond to the short message data, and the recording image data correspond to the long message data.

8. The method of claim 7, wherein in a case that one or more vehicles are involved in an accident, the providing of the data comprises:
receiving vehicle identification information and information on time of the accident, which correspond to one or more accident vehicles, from the external server;
transmitting the vehicle operation data within a time range including the time of the accident of the vehicle corresponding to the vehicle identification information to the external server; and
transmitting the recording image data obtained by a terminal in the accident vehicle or recording image data, in which the accident vehicle is recorded at the time of the accident, to the external server.

9. The method of claim 7, wherein the receiving of the short message data comprises receiving biometric signal data of a driver and further comprises calculating an abnormal state of the driver based on the biometric signal data or an abnormal state of the vehicle based on the vehicle operation data.

10. The method of claim 9, wherein the providing of the data comprises providing notification information to a neighboring vehicle or a rescue vehicle.
